(19) United States
(12) Patent Application Publication
(10) Pub. No.: US 2012/0173920 A1
(43) Pub. Date: Jul. 5, 2012

(54) MEMORY SYSTEM AND METHOD OF OPERATING THE SAME

(76) Inventor: Seong Hun PARK, Chungchongbuk-do (KR)

(21) Appl. No.: 13/340,827

(22) Filed: Dec. 30, 2011

(30) Foreign Application Priority Data
Dec. 30, 2010 (KR) 10-2010-0139185

(51) Int. Cl. G06F 11/07; G06F 11/20

(52) U.S. Cl. 714/6.11; 714/49; 714/E11.024; 714/E11.084

(57) ABSTRACT

A method of operating a memory system includes classifying numbers of total error bits into a plurality of ranges, assigning a plurality of data to the plurality of ranges, respectively, counting a number of detected error bits for a memory cell block, and storing a selected one of the plurality of data in at least one spare cell when the number of the detected error bits is within one of the ranges that corresponds to the selected data.

### CROSS-REFERENCE TO RELATED APPLICATION

Priority to Korean patent application number 10-2010-0139185 filed on Dec. 30, 2010, the entire disclosure of which is incorporated by reference herein, is claimed.

### BACKGROUND

Exemplary embodiments relate to a memory system and a method of operating the same and, more particularly, to a memory system for classifying memory cell blocks according to the number of error bits and a method of operating the same.

After a semiconductor memory device is fabricated, a test operation for determining whether the memory cell blocks of the semiconductor memory device belong to a normal block and an unusable bad block is performed. The test operation may be performed in various ways. One of the methods is to perform a test program operation or a test erase operation using test data. This method is described below.

FIG. 1 is a diagram illustrating a memory cell array.

Referring to FIG. 1, a semiconductor memory device includes a memory cell array 10 including first to M^{th} memory cell blocks. Each of the first to M^{th} memory cell blocks includes a cell group, used by a user, and a spare cell group including spare cells in which various pieces of information, such as program information, repair information, and information about normal blocks or bad blocks, are stored. A test operation for determining whether a specific memory cell block is a normal block or an unusable bad block is described below.

FIG. 2 is a flowchart illustrating a conventional method of operating a memory system.

Referring to FIG. 2, a program or erase operation for a selected memory cell block is performed at step 21. The program or erase operation is a test operation, which is performed like a common program or erase operation. It is determined whether an error bit has occurred during the program or erase operation at step 22. In the program operation, the number of bits of memory cells having threshold voltages not reached a target level is the number of error bits. In the erase operation, the number of bits of memory cells having threshold voltages not being 0 V or lower is the number of error bits. If, as a result of the determination, an error bit is determined not to have occurred, the selected memory cell block is classified as a normal block at step 23. If, as a result of the determination at step 22, an error bit is determined to have occurred, it is determined whether an error correction operation using an error correction code (ECC) can be performed.

The error correction operation cannot be applied to a memory cell block having a large number of error bits. Accordingly, a determination as to whether the error correction operation can be performed is performed by setting in advance a allowable number of error bits for which the error correction operation can be performed and comparing the set number of error bits and the number of detected error bits during the program or erase operation at step 24. That is, if, as a result of the program or erase operation, the number of detected error bits is greater than the set number of error bits, the selected memory cell block is classified as a bad block at step 25. If, as a result of the program or erase operation, the number of detected error bits is equal to or smaller than the set number of error bits, the selected memory cell block is classified as a normal block because the error correction operation for the selected memory cell block can be performed at step 23.

For example, assuming that a set number of allowable error bits is 12 bits among 512 bytes, if the number of detected error bits after a test operation exceeds 12 bits, a relevant memory cell block is classified as a bad block. Here, data regarding each memory cell block (that is, data regarding whether a relevant memory cell block is a normal block or a bad block) is stored in the spare cell group of the relevant memory cell block.

According to data stored in the spare cell group, a memory cell block determined as a normal block is subsequently used to store data, and a memory cell block determined as a bad block is not used to store data.

### BRIEF SUMMARY

According to exemplary embodiments, the states of memory cell blocks are classified according to the number of error bits set variously and relevant data is provided to a user. Accordingly, a user can determine whether to use a specific memory cell block based on data about the memory cell block.

A method of operating a memory system according to an aspect of the present disclosure includes classifying numbers of total error bits into a plurality of ranges; assigning a plurality of data to the plurality of ranges, respectively; counting a number of detected error bits for a memory cell block; and storing a selected one of the plurality of data in at least one spare cell when the number of the detected error bits is within one of the ranges that corresponds to the selected data.

A method of operating a memory system according to another aspect of the present disclosure includes setting the first number of error bits and the second number of fail bits; assigning first data corresponding to a range of the number of fail bits classified into the first number of error bits and the second number of fail bits; performing a least significant bit (LSB) program operation for a memory cell block; storing the first data in at least one spare cell after determining whether a total number of detected error bits after performing the LSB program operation exceeds the first maximum number; performing a most significant bit (MSB) program operation for the memory cell block; and storing the second data in the at least one spare cell after determining whether the total number of detected error bits after performing the MSB program operation exceeds the second maximum number.

A memory system according to yet another aspect of the present disclosure includes a memory cell array configured to include a plurality of memory cell blocks; a controller configured to determine a bad block in response to comparing the counted number of detected error bits to a maximum number of error bits; and an error determination circuit for counting a number of detected error bits in the memory cell block as a result of the read operation.

### BRIEF DESCRIPTION OF THE DRAWINGS

FIG. 1 is a diagram illustrating a memory cell array;

FIG. 2 is a flowchart illustrating a conventional method of operating a memory system;

FIG. 3 is a diagram illustrating a memory system according to this disclosure;

FIG. 4 is a flowchart illustrating an operating method using the memory system of FIG. 3 according to an exemplary embodiment; and

FIG. 5 is a flowchart illustrating an operating method using the memory system of FIG. 3 according to another exemplary embodiment.

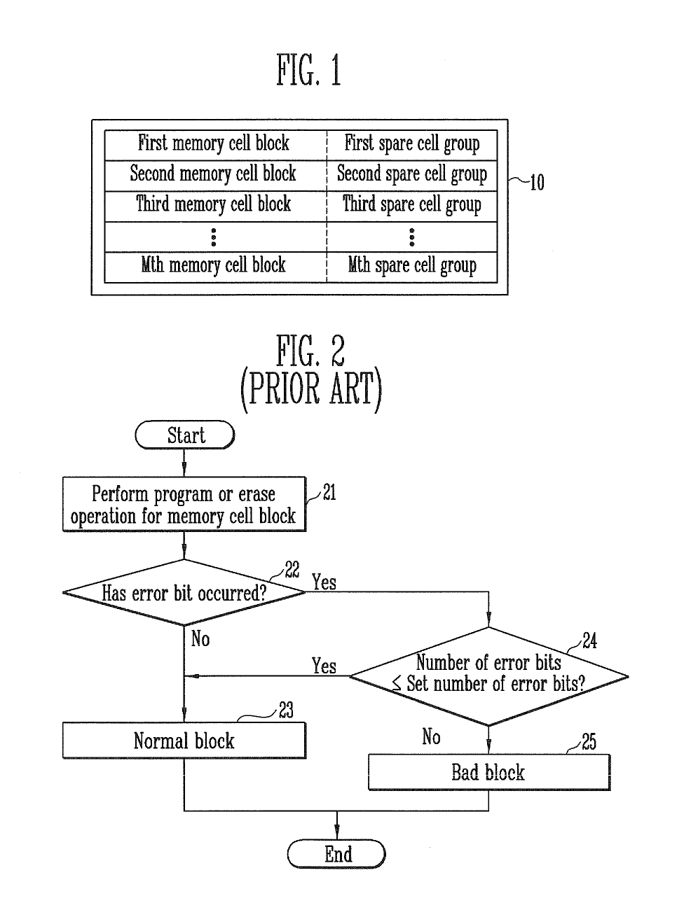

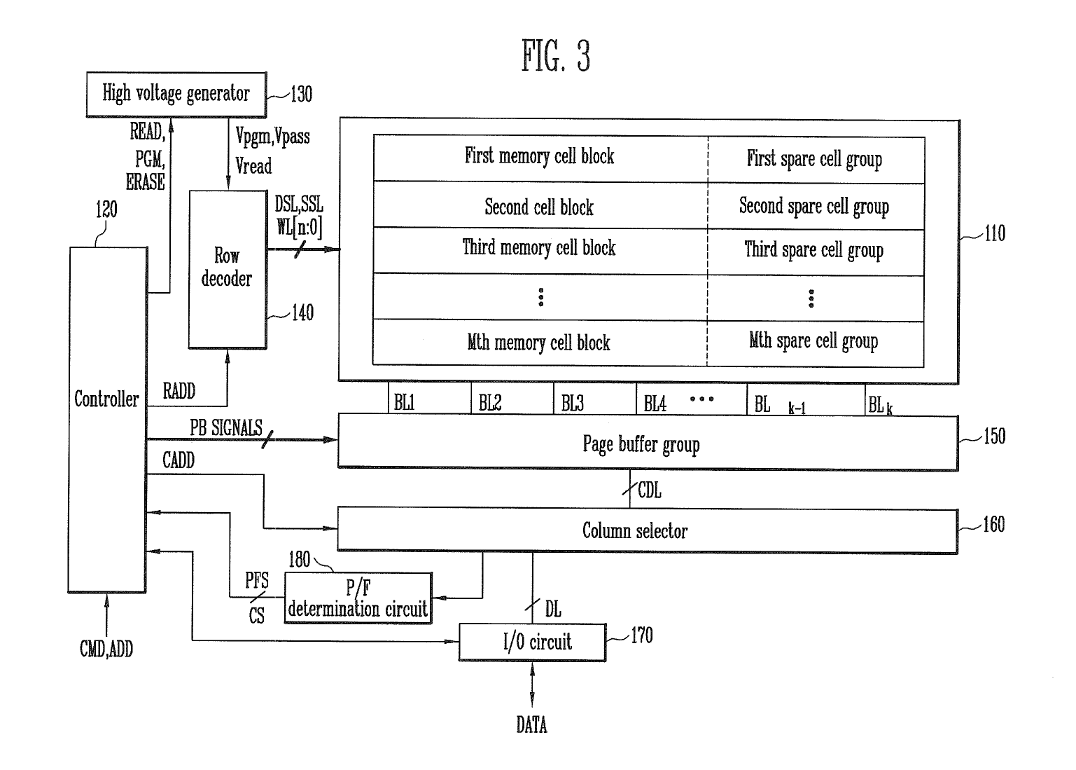

### DESCRIPTION OF EMBODIMENTS

Hereinafter, some exemplary embodiments of the present disclosure will be described in detail with reference to the accompanying drawings. The figures are provided to allow those having ordinary skill in the art to understand the scope of the embodiments of the disclosure.

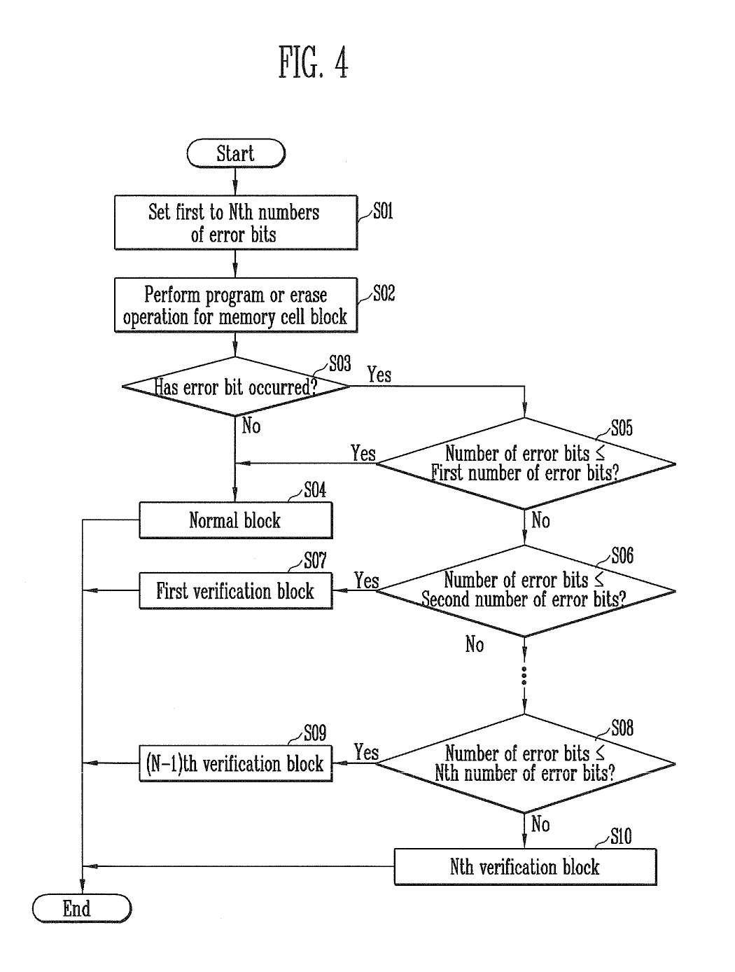

FIG. 3 is a diagram illustrating a memory system according to this disclosure.

Referring to FIG. 3, the memory system includes a memory cell array 110, an operation circuit group (130, 140, 150, 160, 170, and 180) for performing a program operation or a read operation for the memory cells of the memory cell array 110, and a controller 120 for controlling the operation circuit group (130, 140, 150, 160, 170, and 180) so that a program verification operation is performed in order so that memory cells programmed with a higher level are verified later.

In the case of a NAND flash memory device, the operation circuit group includes a high voltage generator 130, a row decoder 140, a page buffer group 150, a column selector 160, an I/O circuit 170, and a pass/fail (P/F) determination circuit 180.

The memory cell array 110 includes first to M^{th} memory cell blocks. Each of the memory cell blocks includes a normal cell group used by a user and a spare cell group configured to store various pieces of information, such as the degree of a program, repair information, and information about normal blocks or bad blocks. The spare cell group includes memory cells having the same structure as the memory cells of the normal cell group.

The controller 120 generates a program operation signal PGM, a read operation signal READ, or an erase operation signal ERASE in response to a command signal CMD and also generates control signals PB SIGNALS for controlling the page buffers (not shown) of the page buffer group 150 according to different operations. Furthermore, the controller 120 internally generates a row address signal RADD and a column address signal CADD in response to an address signal ADD. The controller 120 determines whether all program data has been inputted to the page buffer group 150 based on a count signal CS generated by the P/F determination circuit 180 in a program operation, determines whether the threshold voltages of memory cells have risen to a target level based on a determination signal PFS generated by the P/F determination circuit 180 after a program verification operation, and determines whether to perform the program operation again or terminate the program operation according to a result of the determination.

The voltage supply circuit (130, 140) supplies the drain select line DSL, the word lines WL0 to WLn, and the source select line SSL of a selected memory block with operating voltages for the program operation, the erase operation, the read operation, the verification operation, or the verification determination operation of memory cells in response to the signals READ, PGM, ERASE, and RADD of the controller 120. The voltage supply circuit includes the high voltage generator 130 and the row decoder 140.

The high voltage generator 130 outputs operating voltages for programming, reading, and erasing memory cells to global lines in response to the signals PGM, READ, and ERASE and outputs operating voltages (for example, Vpgm, Vpass, and Vread) for a program to the global lines when memory cells are programmed.

The row decoder 140 transfers the operating voltages of the voltage generator 130 to a memory block of the memory cell array 110 in response to the row address signals RADD of the controller 120. That is, the operating voltages are supplied to the local lines DSL, WL[n:0], and SSL of the memory block.

The page buffer group 150 includes the page buffers (not shown) coupled to the respective bit lines BL1 to BLk. The page buffer group 150 supplies voltages to store data in the memory cells of a memory cell block through the bit lines BL1 to BLk in response to the control signals PB SIGNALS of the controller 120. More particularly, in the program operation, the erase operation, or the read operation, the page buffer group 150 precharges the bit lines BL1 to BLk or latches data corresponding to the threshold voltages of memory cells which are detected according to a shift in the voltages of the bit lines BL1 to BLk.

The column selector 160 selects the page buffers of the page buffer group 150 in response to the column address signal CADD of the controller 120 and outputs data DATA latched in the selected page buffers.

The I/O circuit 170 transfers external data DATA to the column selector 160 under the control of the controller 120 during a program operation so that the data is inputted to the page buffer group 150. When the column selector 160 sequentially transfers the data to the page buffers of the page buffer group 150, the page buffers store the data in their latches. Furthermore, when a read operation is performed, the I/O circuit 170 externally outputs data DATA received via the column selector 160 from the page buffers of the page buffer group 150.

The P/F determination circuit 180 determines whether there is a memory cell having a threshold voltage lower than a target level, from among programmed memory cells, in a program verification operation performed after a program operation and generates a result of the determination as the determination signal PFC. The P/F determination circuit 180 also counts the number of error bits and generates a result of the count as the count signal CS.

The controller 120 compares a set number of error bits and the count signal CS and performs control so that data regarding the state of a relevant memory cell block is stored in the spare cells of a spare cell group corresponding to the relevant memory cell block according to a result of the comparison.

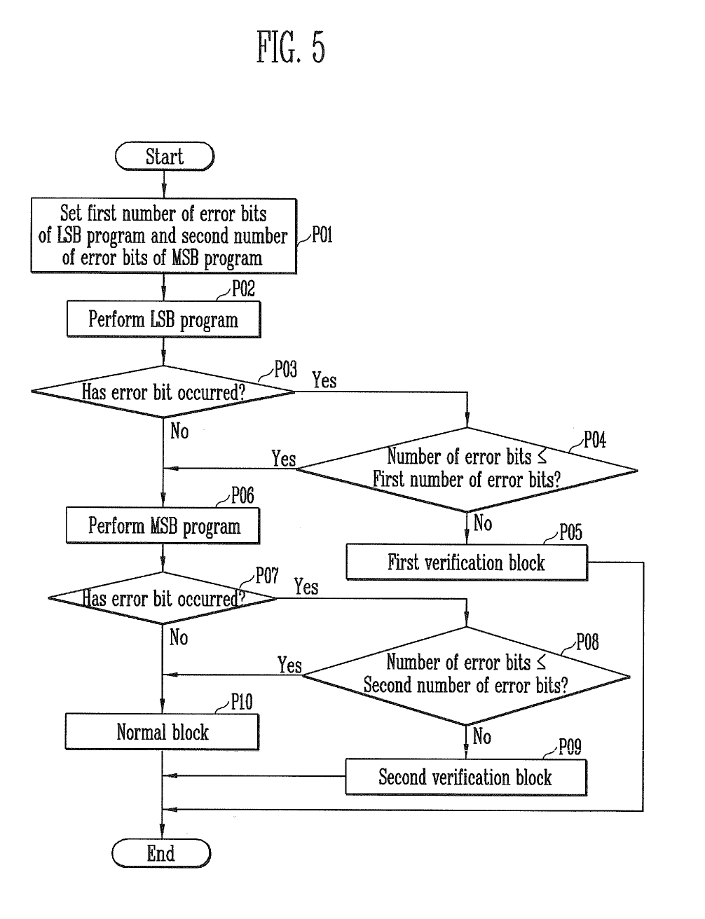

FIG. 4 is a flowchart illustrating an operating method using the memory system of FIG. 3 according to an exemplary embodiment. The method of FIG. 4 may be used to perform a program operation for single level cell (SLC).

Referring to FIG. 4, the first to N^{th} numbers of error bits are set at step S01. The set numbers of error bits are 2 kinds or more. Data values are assigned to the first to N^{th} numbers of error bits, respectively. For example, data ‘001’, ‘010’, ‘011’, and so on may be assigned to the first to N^{th} numbers of error bits, respectively. The data may be stored in the controller 120 or may be stored in a separate register.

For example, if the number of different set numbers of error bits is equal to N, the smallest and the first set number of error bits may correspond to a minimum number of error bits for which an error correction operation using an ECC code can be performed. That is, the first set number of error bits is defined as the total allowed number of error bits in a semiconductor memory device.

One of the first to N^{th} memory cell blocks is selected, and a program or erase operation for testing the selected memory cell block is performed at step S02. The test operation may be performed according to any reasonably suitable program or erase operation using test data. During the program or erase operation, it is determined whether one or more error bits have occurred at step S03. If, as a result of the determination, error bits are determined not to have occurred, the selected memory cell block is classified as a normal block at step S04, and relevant data is stored in the one or more spare cells of the selected memory cell block.

If, as a result of the determination at step S03, error bits are determined to have occurred, it is determined whether the number of detected error bits is greater than the first set/maximum number of error bits at step S05. If, as a result of the determination at step S05, the number of error bits is equal to or smaller than the first set number of error bits, the selected memory cell block is classified as a normal block, and the process proceeds to step S04.

If, as a result of the determination at step S05, the number of error bits is greater than the first set number of error bits, it is determined whether the number of detected error bits is greater than the second set number of error bits greater than the first set number of error bits at step S06. If, as a result of the determination at step S06, the number of detected error bits is equal to or smaller than the second set/maximum number of error bits, the selected memory cell block is defined as a first verification block at step S07, and relevant data is stored in the one or more spare cells of the selected memory cell block.

However, if, as a result of the determination at step S06, the number of error bits is greater than the second set number of error bits, it is determined whether the number of detected error bits is greater than the next set number of error bits. This process proceeds until the N^{th} set number of error bits is reached. That is, it is determined whether the number of detected error bits is greater than the N^{th} set number of error bits at step S08. If, as a result of the determination at step S08, the number of error bits is equal to or smaller than the N^{th} number of error bits, the selected memory cell block is classified as an (N−1)^{th} verification block at step S09. If, as a result of the determination at step S08, the number of error bits is greater than the N^{th} number of error bits, the selected memory cell block is classified as an N^{th} verification block at step S10, and the process is then terminated. Likewise, the states of all the memory cell blocks are classified according to the number of detected error bits.

As described above, when a selected memory cell block is classified as a normal block or as one of the first to N^{th} verification blocks and relevant data is stored in a spare cell group (one or more spare cells) corresponding to the selected memory cell block, a next memory cell block is selected and the test operation is then performed. Data, such as ‘AAh’, ‘55h’, or 00h’, may be stored in the spare cell group (one or more spare cells, where a same spare cell may store any one of the different data) of the selected memory cell block according to the determined state of the selected memory cell block.

In the present disclosure, the states of memory cell blocks are classified according to the number of detected error bits, and relevant data is provided to a user. Here, the method of storing the data in the spare cell group may be performed in various ways.

FIG. 5 is a flowchart illustrating an operating method using the memory system of FIG. 3 according to another exemplary embodiment.

A multi-level cell (MLC) program operation is more complicated than a single level cell (SLC) program operation (for example, the program operation described in FIG. 4) because one memory cell is programmed for various threshold levels. For this reason, a memory cell block classified as a bad block in the MLC program operation may be classified as a normal block in the SLC program operation. In this case, in order to provide relevant information to a user, the following test operation is performed.

The test operation is performed according to the MLC program operation. The MLC program operation is performed in such a way to perform an LSB program operation and subsequently perform an MSB program operation. Here, the LSB program operation is the same as the SLC program operation described above except a target level.

First, the first set number of error bits (that is, the allowable number of error bits in the LSB program operation) and the second set number of error bits (that is, the allowable number of error bits in the MSB program operation) are set at step P01. The first set number of error bits and the second set number of error bits may be the same or different from each other.

Next, one of the first to N^{th} memory cell blocks is selected, and the LSB program operation for the selected memory cell block is performed at step P02. The LSB program operation is performed according to a common LSB program operation using test data.

It is then determined whether the error bits have occurred at step P03. If, as a result of the determination, error bits are determined not to have occurred, the MSB program operation for the selected memory cell block is performed at step P06.

It is then determined whether the error bits have occurred at step P07. If, as a result of the determination, error bits are determined not to have occurred, the selected memory cell block is classified as a normal block at step P10.

If, as a result of the determination at step P03, error bits are determined to have occurred, it is determined whether the number of detected error bits is greater than the first set number of error bits at step P04. If, as a result of the determination at step P04, the number of detected error bits is equal to or smaller than the first set number of error bits, it means that the selected memory cell block is a memory cell block for which an error correction operation can be performed. Accordingly, the process proceeds to step S06 in which the MSB program operation for the selected memory cell block is performed. In other words, the number of detected error bits as a result of the LSB program operation is the first set number of error bits or less, the selected memory cell block is classified as a normal block.

If, as a result of the determination at step P04, the number of detected error bits is greater than the first set number of error bits, the selected memory cell block is classified as a first verification block at step P05, and the process is then terminated. Here, the verification/classification can be stored in a spare memory cell block.

Meanwhile, if, as a result of the determination at step P07, error bits are determined to have occurred as a result of the MSB program operation, it is determined whether the number of detected error bits is greater than the second set number of error bits at step P08. If, as a result of the determination at step P08, the number of detected error bits is equal to or smaller than the second set number of error bits, the process proceeds to step P10 in which the selected memory cell block is classified as a normal block.

If, as a result of the determination at step P08, the number of detected error bits is greater than the second set number of error bits, the selected memory cell block is classified as a second verification block at step P09, and the process is then terminated. Here, the verification/classification can be stored in a spare memory cell block.

As a result of the test program operation, data regarding whether the selected memory cell block is the normal block, the first verification block, or the second verification block is stored in the same spare memory cell block (one or more spare cells) corresponding to the selected memory cell block. A memory cell block classified as the first verification block corresponds to a memory cell block in which the number of detected error bits in an LSB program operation exceeds the first set number of error bits. Step P05 leads to a classification of the first verification block as a bad block.

If a memory cell block is classified as the second verification block, the memory cell block is a bad block in which the allowable number of detected error bits in the MSB program operation exceeds the second set number of error bits. Accordingly, if data of a memory cell block stored in a relevant spare cell group indicates the second verification block, a user can classify the memory cell block as a SLC program-dedicated memory cell block and use the memory cell block for, for example, SLC program only. That is, the memory cell block can be designated as an SLC program operation-dedicated memory cell block for subsequent use to store data. Here, according to an example, the verification/classification from steps P05, P09, and P10 can be stored in a same spare memory cell.

As described above, since a test result of each memory cell block is provided to a user, the user can determine whether to use the memory cell block based on the test result. Furthermore, a user may use a memory cell block in which the number of detected error bits exceeds the allowable number of error bits according to different purposes. According to the present disclosure, a reduction in the number of available memory cell blocks can be reduced because a user can determine whether to use a memory cell block designated as a bad block in a known test operation.

What is claimed is:

1. A method of operating a memory system, comprising:
classifying numbers of total error bits into a plurality of ranges;
assigning a plurality of data to the plurality of ranges, respectively;
counting a number of detected error bits for a memory cell block; and
storing a selected one of the plurality of data in at least one spare cell when the number of the detected error bits is within one of the ranges that corresponds to the selected data.

2. The method claim 1, wherein in the range of the number of fail bits, a smallest number of error bits is a valid number of fail bits.

3. The method claim 2, wherein the smallest maximum number indicates a maximum number of total error bits for performing an error correction operation.

4. The method claim 1, wherein the counting of the number of detected error bits comprises performing a test program or an erase operation for the memory cell block and subsequently counting the number of detected error bits.

5. The method claim 4, wherein the test program or erase operation is performed using test data.

6. The method claim 2, wherein the memory cell block is classified as a normal block when an error bit is not generated or the number of detected error bits does not exceed the smallest maximum number.

7. The method claim 6, wherein if the number of detected error bits is greater than the smallest maximum number, the number of detected error bits is compared with the next smallest maximum number.

8. The method claim 1, wherein the at least one spare cell is included in memory cells of the memory cell block.

9. A method of operating a memory system, comprising:
setting a first number of error bits and a second number of fail bits;
assigning first data corresponding to a range of a number of fail bits classified into the first number of error bits and the second number of fail bits;
performing a least significant bit (LSB) program operation for a memory cell block;
storing the first data in at least one spare cell after determining whether a total number of detected error bits after performing the LSB program operation exceeds the first maximum number;
performing a most significant bit (MSB) program operation for the memory cell block; and
storing the second data in the at least one spare cell after determining whether the total number of detected error bits after performing the MSB program operation exceeds the second maximum number.

10. The method claim 9, wherein the first maximum number of error bits and the second maximum number of error bits are the same.

11. The method claim 9, wherein the first and second maximum numbers determine whether the memory cell block is a normal block or a bad block.

12. The method claim 11, wherein the first maximum number indicates a maximum number of error bits for performing an error correction operation.

13. The method claim 9, wherein if the number of detected error bits as a result of the LSB program operation does not exceed the first maximum number of error bits, the MSB program operation for the memory cell block is performed.

14. The method claim 9, wherein if an error cell is not generated as a result of the MSB program operation, the memory cell block is classified as a normal block and data regarding the memory cell block is stored in the at least one spare cell.

15. The method claim 9, wherein if the number of detected error bits as a result of the MSB program operation does not exceed the second maximum number of error bits, the memory cell block is classified as a normal block and data regarding the memory cell block is stored in the at least one spare cell.

16. The method claim 9, wherein the at least one spare cell includes a spare cell to selectively store one of the first data and second data based on the determinations as to whether the total number of detected error bits exceed the first or second maximum number, respectively.

17. A memory system, comprising:
a memory cell array configured to comprise a plurality of memory cell blocks;
a controller configured to determine a bad block in response to comparing the counted number of detected error bits to a maximum number of error bits; and
an error determination circuit for counting a number of detected error bits in the memory cell block as a result of the read operation.

18. The method claim 17, wherein the error determination circuit is configured to output a signal indicating the counted number of detected error bits.

19. The method claim 17, wherein the controller is configured to store data indicating a state of the memory cell block in at least one spare cell corresponding to the memory cell block according to a result of the comparison.
